(19) United States
(12) Patent Application Publication
(10) Pub. No.: US 2007/0274675 A1
(43) Pub. Date: Nov. 29, 2007

(54) Method and Apparatus for Transcoding Digital Audio/Video Streams

(75) Inventor: Sung Wan Park, Suwon-si (KR)

Correspondence Address: BIRCH STEWART KOLASCH & BIRCH, PO BOX 747, FALLS CHURCH, VA, 22040-0747, US

(73) Assignees: LG Electronics Inc.; LG Electronics Inc., Seoul (KR)

(21) Appl. No.: 10/581,286

(22) PCT Filed: Nov. 30, 2004
(86) PCT No.: PCT/KR04/03118

§ 371 Date: Apr. 2, 2007

(30) Foreign Application Priority Data
Dec. 1, 2003 (KR) 10-2003-0086252

(51) Int. Cl. H04N 5/91

(52) U.S. Cl. 386/66; 386/E05.003

(57) ABSTRACT

A device and method for transcoding digital audio/video streams. Only the video data, from among audio/video data provided in the form of compressed digital streams such as TV broadcast streams, is transcoded, and then the transcoded video data is synchronized with the audio data. To synchronize the transcoded video data with the audio data, original Presentation Time Stamps (PTSs) of the video data before the transcoding are used for the transcoded video data, or new PTSs are used for the transcoded video data and PTSs of the audio data are updated based on the new PTSs. The transcoding and PTS synchronization is performed on the basis of sections having continuous PTS values. Accordingly, degradation of sound quality due to unnecessary audio data transcoding is avoided, while preventing synchronization mismatching between the audio and video data in the transcoding procedure.

### TECHNICAL FIELD

The present invention relates to a method and apparatus for transcoding digital audio/video streams, and more particularly to a method for synchronizing video and audio data in the form of compressed digital streams while transcoding only the video data, and an apparatus using the method.

### BACKGROUND ART

FIG. 1 is a schematic block diagram of a conventional digital recorder 100.

The digital recorder 100 includes a storage unit 110, a record/play system 120, a microcomputer 130, an OSD generator 140, and a memory 150.

The storage unit 110 may use a large capacity recording medium such as a hard disk (HDD). The storage unit 110 may further include an optical disc such as a recordable DVD (DVD-R/RW) or alternatively may use the optical disc in place of the hard disk. The storage unit 110 may store MPEG A/V data, and may also store various audio files such as MP3 audio files and various image files such as JPEG or BMP files.

At the request of the user, the microcomputer 130 controls the record/play system 120 to play A/V files, audio files, and image files recorded in the storage unit 110 and output their signals to an external unit such as a television. The microcomputer 130 also controls the OSD generator 140 to display an OSD screen including A/V, audio, or image file lists so that the user can select and play a desired A/V, audio, or image file.

Further, the microcomputer 130 controls the record/play system 120 to record A/V data in the form of compressed digital streams such as digital TV broadcast streams in the storage unit 110. When the user requests more efficient use of the recording medium, the microcomputer 130 controls the record/play system 120 to transcode and store the A/V data. That is, the microcomputer 130 controls the record/play system 120 to decode the A/V data in the form of compressed digital streams, transcode the decoded A/V data (i.e., encode it by changing its bit rate (i.e., its compression ratio)), and store the transcoded A/V data. Here, the transcoding of the A/V data is typically performed in association with resizing of video data, i.e., a reduction in the resolution of video data.

In order for the transcoded A/V data to be correctly decoded, the audio data must be correctly synchronized with the video data, and, to accomplish this, time-related information must be incorporated into the A/V data in the encoding procedure and then transferred to the decoder.

According to the MPEG standard, audio and video data is synchronized using a System Time Clock (STC). Time stamps are produced based on the STC in order to indicate accurate presentation time and decoding time of audio and video data. Such time stamps include a presentation time stamp (PTS) indicating presentation time of audio and video data, and a decoding time stamp indicating decoding time thereof.

Using PTSs and DTSs, time intervals at which audio and video data is decoded in the decoder are made equal to time intervals at which audio and video data is encoded in the encoder, so that the audio and video data is properly decoded. Also, System Clock References (SCRs) are used for program streams, and Program Clock References (PCRs) are used for transport streams in order to synchronize an STC in the encoder with an STC in the decoder.

The encoder incorporates its STC value into SCRs or PCRs at predetermined intervals, and the decoder sets its STC value based on the SCRs or PCRs received from the encoder. Specifically, the encoder samples system clock values calculated by its STC at predetermined intervals, and combines the sampled system clock values, as PCR values, with transport streams, and transmits the combined transport streams. At the moment that it receives a PCR value, the decoder updates its system clock using the received PCR value, and uses the updated system clock as its system clock afterwards. In this manner, the decoder can decode audio and video data at the times specified by the encoder.

Since the amount of audio data is typically smaller than that of video data, the total amount of data stored in the storage unit 110 depends mainly on video data stored therein, and, in addition, a reduction in the amount of audio data according to the change in its compression ratio is very small as compared to that of video data. Although transcoding is minimally effective or necessary for audio data, in the past, transcoding has been performed not only for video data but also for audio data. The unnecessary transcoding deteriorates the sound quality of the audio data.

In the case where audio data is transcoded and stored together with video data and the stored audio data is then reproduced, synchronization between the audio and video data fails in the procedure of transcoding the audio data or expanding the transcoded audio data.

### DISCLOSURE OF INVENTION

Therefore, the present invention has been made in view of the above problems, and it is an object of the present invention to provide a method and apparatus for transcoding digital audio/video streams, wherein when audio and video data input in the form of compressed digital streams is transmitted or recorded in a recording medium, only the video data is transcoded.

It is another object of the present invention to provide a method and apparatus for transcoding digital audio/video streams, wherein when audio and video data input in the form of compressed digital streams is transmitted or recorded after transcoding only the video data, the audio data is synchronized with the transcoded video data.

In accordance with an aspect of the present invention, the above and other objects can be accomplished by the provision of a method for transcoding an audio/video (A/V) stream, the method comprising dividing a compressed digital A/V stream into audio and video data; transcoding the divided video data; synchronizing the divided audio data with the transcoded video data; and packetizing the synchronized audio and video data into a digital A/V stream.

The transcoding comprises reducing bit rate of the video data, and the bit rate of the video data is reduced by reducing at least one of a frame size, a frame quality and a frame rate of the video data.

The divided audio data is synchronized with the transcoded video data by matching Presentation Time Stamps (PTSs) of the audio and video data. One method of matching PTSs of the audio and video data is to use original PTSs of video data prior to the transcoding for the transcoded video data.

Another method of matching PTSs of the audio and video data is to use new PTSs for the transcoded video data and update PTSs of the audio data based on the new PTSs. In this method, a start PTS value of the PTSs of the audio data is replaced with a start PTS value of the new PTSs of the transcoded video data, and the other PTS values of the PTSs of the audio data are updated based on the difference between the start PTS value of the new PTSs of the transcoded video data and the start PTS value of the PTSs of the audio data, wherein the transcoding and the synchronizing are performed on a section-by-section basis, each section having continuous PTS values.

The divided audio data is temporarily stored in a buffer while the video data is being transcoded, where the size of the buffer is determined based on both a time required to transcode the video data and the bit rate of the audio data.

The compressed digital A/V stream may be received via a digital broadcast or input through a multimedia player, and the packetized digital A/V stream may be recorded in a recording medium or transmitted.

In accordance with another aspect of the present invention, there is provided an apparatus for transcoding a digital audio/video (A/V) stream, the apparatus comprising a demultiplexer for dividing a compressed digital A/V stream into audio and video data; a buffer for temporarily storing the divided audio data; a transcoder for transcoding the divided video data; a synchronizer for synchronizing the divided audio data with the transcoded video data; and a packetizer for packetizing the synchronized audio and video data into a digital A/V stream.

The apparatus may further comprise a digital broadcast receiver for receiving the compressed digital A/V stream via a digital broadcast; and a recorder for recording the packetized digital A/V stream in a recording medium.

The apparatus may further comprise a transmitter for transmitting the packetized digital A/V stream to a client computer through a communication network.

### BRIEF DESCRIPTION OF DRAWINGS

The accompanying drawings, which are included to provide a further understanding of the invention, illustrate the preferred embodiments of the invention, and together with the description, serve to explain the principles of the present invention.

FIG. 1 is a schematic block diagram of a conventional digital recorder;

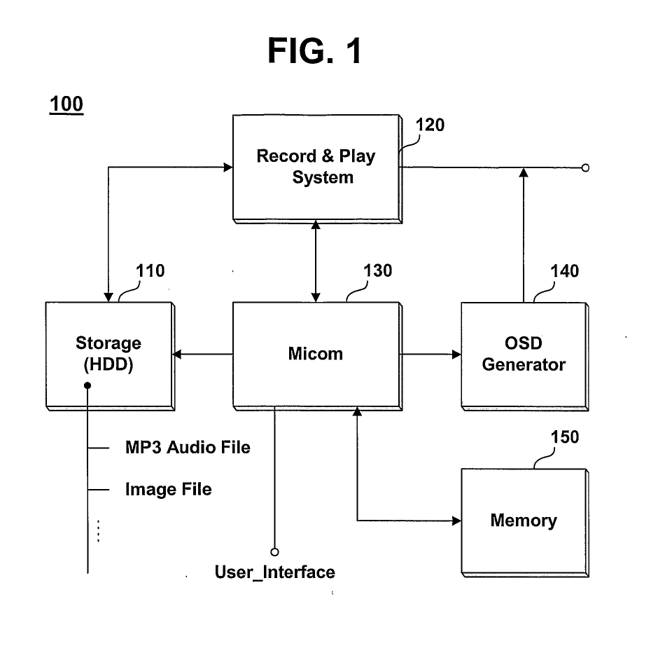

FIG. 2 is a schematic block diagram of an apparatus for transcoding digital A/V streams, to which a digital A/V stream transcoding method according to an embodiment of the present invention is applied;

FIG. 3 is a schematic block diagram of a digital TV broadcast receiver for receiving and displaying a digital A/V stream transmitted from a digital A/V stream transcoding apparatus according to the present invention; and

FIG. 4 is a schematic block diagram of an Internet broadcasting system when the digital A/V stream transcoding apparatus according to the present invention is applied to an Internet broadcast transmitter.

Features, elements, and aspects of the invention that are referenced by the same numerals in different figures represent the same, equivalent, or similar features, elements, or aspects in accordance with one or more embodiments.

### BEST MODE FOR CARRYING OUT THE INVENTION

Now, preferred embodiments of the present invention will be described in detail with reference to the accompanying drawings. In the drawings, the same or similar elements are denoted by the same reference numerals even though they are depicted in different drawings. In the following description of the present invention, a detailed description of known functions and configurations incorporated herein will be omitted when it may obscure the subject matter of the present invention.

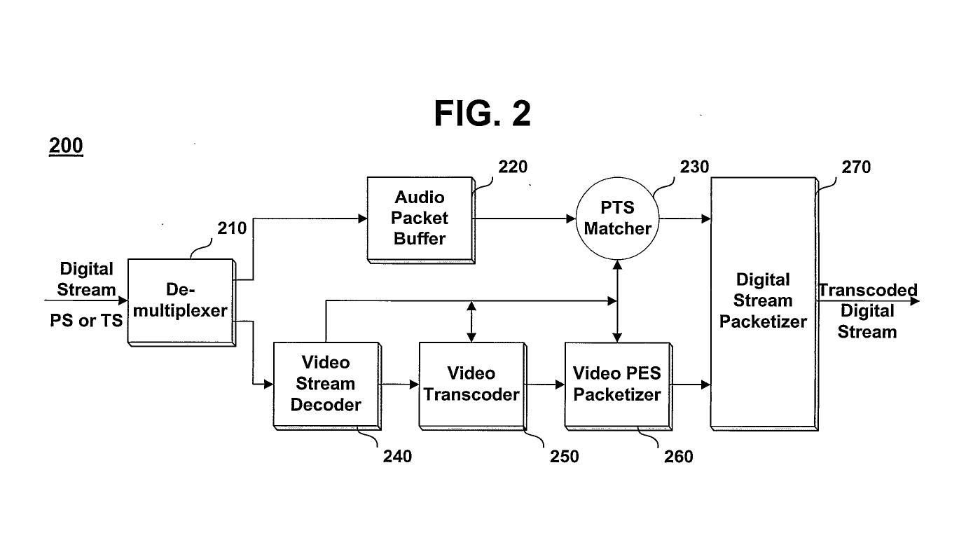

FIG. 2 is a schematic block diagram of an apparatus 200 for transcoding digital A/V streams, to which a digital A/V stream transcoding method according to an embodiment of the present invention is applied.

The digital A/V stream transcoding apparatus 200 according to the present invention comprises a demultiplexer 210, an audio packet buffer 220, a PTS matcher 230, a video stream decoder 240, a video transcoder 250, a video Packetized Elementary Stream (PES) packetizer 260, and an A/V stream packetizer 270. The digital A/V stream transcoding apparatus 200 can be applied to an optical disc recording device and a digital recorder for recording A/V data.

The demultiplexer 210 functions to divide a received digital A/V stream such as a program stream or a transport stream into audio PES packets and video PES packets. Original synchronized PTSs have been inserted respectively in the audio and video PES packets. Program or transport streams can be received via digital broadcasts or received through a multimedia player such as an optical disc player provided inside or outside of the apparatus 200.

The audio packet buffer 220 functions to temporarily store audio PES packets separated from a received A/V stream. The size of the audio packet buffer 220 is determined based on both the time required to transcode video PES packets and the bit rate of audio PES packets.

The PTS matcher 230 functions to update PTSs of transcoded video elementary streams and/or PTSs of audio PES packets in order to synchronize the audio data with the transcoded video data.

The video stream decoder 240 functions to decode video PES packets into video elementary streams and extract their original PTSs from the video PES packets. The video transcoder 250 functions to compress the decoded video elementary streams through a predetermined codec. The video PES packetizer 260 packetizes the transcoded video elementary streams.

Transcoding is typically performed to more effectively utilize storage capacity or to cope with limited transfer rates. According to the present invention, transcoding is performed to reduce the bit rate of video data that occupies a considerable portion of the total data of A/V streams. Typically, in order to reduce the bit rate of video data, its frame size (i.e., its resolution) is reduced, or its frame quality, which is the number of bits per pixel, is reduced, or its frame rate, which is the number of frames per second, is reduced.

The digital A/V stream packetizer 270 combines audio PES packets, which are not transcoded, and transcoded video PES packets to packetize them into a digital A/V stream.

One method of synchronizing the transcoded video data with the audio data is to use original PTSs of video PES packets extracted by the video stream decoder 240 when the video transcoder 250 transcodes decoded video elementary streams. Another method is to use new PTSs for decoded video elementary streams when the video transcoder 250 transcodes the decoded video elementary streams and then to update PTSs of audio PES packets based on the new PTSs.

In the second method, PTS values of audio PES packets are updated through calculation based on the difference between the value of a start one of the new PTSs used when transcoding video elementary streams and the value of a start one of the original PTSs of audio PES packets. For example, if the value of the start one of the new PTSs for transcoded video PES packets is determined to be “1000” when the value of the start one of the original PTSs of audio PES packets is “5000”, the start PTS value of the audio PES packets is updated to “1000”, and the other PTS values thereof are updated to values calculated by adding the difference “−4000” between the start PTS “1000” for the transcoded video PES packets and the original start PTS “5000” of the audio packets to their original PTS values.

The received digital A/V stream typically has continuous PTS values. When it has been edited, the received digital A/V may have discrete sections, each having continuous PTS values. In this case, the operation of transcoding video PES packets is performed on a section-by-section basis, each section having continuous PTS values. The operation of updating PTSs of audio or video PES packets in order to synchronize the audio and video data is also performed on a section-by-section basis, each section having continuous PTS values.

The digital A/V stream transcoding apparatus 200 according to the present invention can be applied to a digital TV broadcast transmitter and receiver.

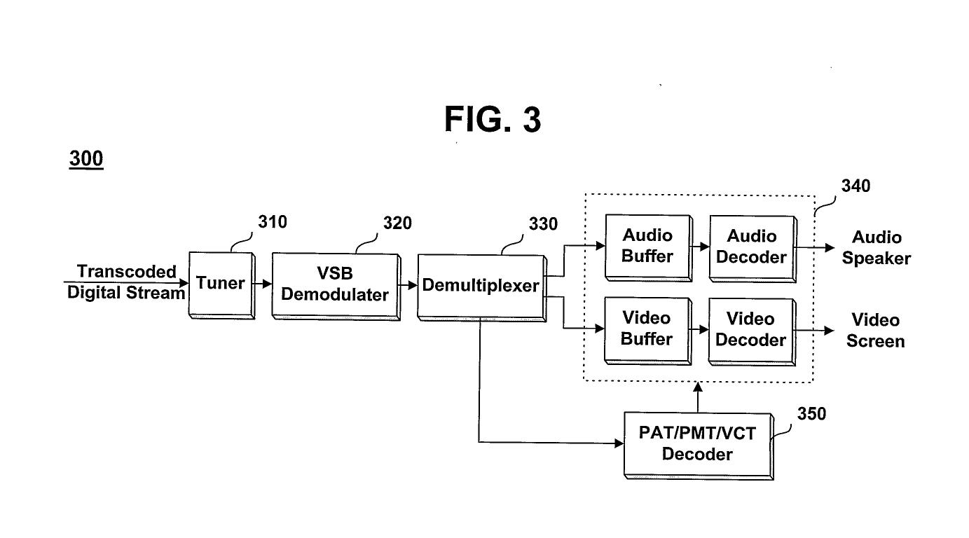

FIG. 3 is a schematic block diagram of a digital TV broadcast receiver 300 for receiving and displaying a digital A/V stream transmitted from a digital A/V stream transcoding apparatus 200 according to the present invention when the digital A/V stream transcoding apparatus 200 is applied to a digital TV broadcast transmitter.

The digital TV broadcast receiver 300 comprises a tuner 310, a VSB demodulator 320, a demultiplexer 330, an A/V decoder 340, and a PAT/PMT/VCT decoder 350. The tuner 310 receives a broadcast signal, is tuned to a channel desired by the user, and detects signals of the tuned channel. The VSB demodulator 320 demodulates the signals output from the tuner 310 into MPEG-2 transport streams. The demultiplexer 330 extracts one of the transport streams output from the VSB demodulator 320, and demultiplexes the extracted stream into an A/V PES and Program Specific Information (PSI). The A/V decoder 340 decodes the A/V PES into audio and video signals and outputs the decoded signals to an A/V output unit (not shown). The PAT/PMT/VCT decoder 350 decodes the PSI information output from the demultiplexer 330 into a Program Association Table (PAT), a Program Map Table (PMT), and a Virtual Channel Table (VCT).

The digital TV broadcast receiver 300 configured as described above operates in the following manner.

According to user selection, a broadcast signal received through an antenna is tuned to and detected by the tuner 310. The broadcast signal is then demodulated into an MPEG-2 transport stream through the VSB demodulator 320.

The demultiplexer 330 demultiplexes the MPEG-2 transport stream output from the VSB demodulator 320 into an A/V PES and PSI information, which is secondary service data. The A/V decoder 340 buffers audio PES packets in an audio buffer, and buffers video PES packets in a video buffer. While performing synchronization between the audio and video data based on PTS information inserted in each of the audio and video PES packets, the A/V decoder 340 decodes and outputs the audio PES packets to an audio output unit (for example, an audio speaker), and decodes and outputs the video PES packets to a video display unit (for example, a video screen), so that video is displayed on the video display unit and audio corresponding to the video is output through the audio output unit.

The PAT/PMT/VCT decoder 350 decodes the PSI information output from the demultiplexer 330 into a Program Association Table (PAT), a Program Map Table (PMT), and a Virtual Channel Table (VCT), and outputs them to the A/V decoder 340 or a central processing unit (not shown) so as to provide overall information of the program.

The digital A/V stream transcoding apparatus 200 according to the present invention can also be applied to an Internet broadcasting system for providing multimedia services over the Internet.

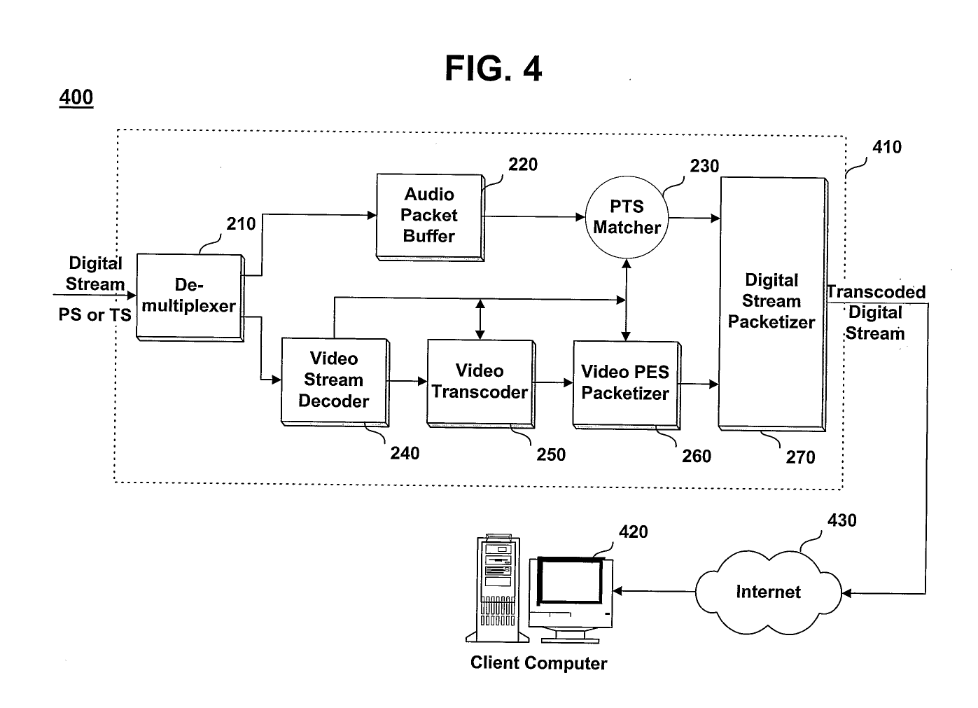

FIG. 4 is a schematic block diagram of an Internet broadcasting system 400 when the digital A/V stream transcoding apparatus 200 according to the present invention is applied to an Internet broadcast transmitter.

The Internet broadcasting system 400 includes a digital broadcast station 410 for converting video data produced by capturing images of an object into a digital stream and providing the digital stream to the Internet 430, a client computer 420 for receiving the digital stream provided from the digital broadcast station 410 and outputting the received digital stream as audio and video data, and the Internet 430 for providing a transport path, through which the digital stream provided from the digital broadcast station 410 is transmitted to the client computer 420.

The digital broadcast station 410 includes the components of the digital A/V stream transcoding apparatus 200 as shown in FIG. 4. The digital broadcast station 410 also includes a device for capturing images of an object, and a device for editing the captured audio and video signals. These components are known in the art and thus they are not shown and a description thereof is omitted herein.

In the Internet broadcast system 400 configured as described above, the digital broadcast station 410 provides a web page having an Internet address that allows the client computer 420 to access it over the Internet 430. The digital broadcast station 410 converts audio and video signals obtained by capturing images of an object into digital audio and video streams. Through the digital A/V stream transcoding apparatus 200 according to the present invention, the digital broadcast station 410 transcodes only the video stream while maintaining the audio stream in its original state, and synchronizes PTSs of the video and audio streams. The digital broadcast station 410 then transmits the transcoded digital video and audio streams to the Internet 430.

Using the client computer 420, the user gains access to the digital broadcast station 410 over the Internet 430, and receives digital streams of a broadcast provided by the digital broadcast station 410. For example, the user plays and views the received digital streams using a multimedia player such as a Window Media Player. The client computer 420 divides the digital streams received from the digital broadcast station 410 into audio and video streams, and decodes the audio and video streams into original audio and video signals to play the original audio and video signals.

As is apparent from the above description, the present invention provides an apparatus for transcoding digital audio/video streams, which has the following advantages.

Audio data is not transcoded when audio/video data in the form of compressed digital streams is transmitted or recorded in a recording medium, thereby preventing degradation of sound quality.

In addition, synchronization failure between audio and video data is prevented when only the video data is transcoded.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for transcoding an audio/video (A/V) stream, the method comprising:
dividing a compressed digital A/V stream into audio and video data;
transcoding the divided video data;
synchronizing the divided audio data with the transcoded video data; and
packetizing the synchronized audio and video data into a digital A/V stream.

2. The method according to claim 1, wherein the transcoding comprises reducing a bit rate of the video data.

3. The method according to claim 2, wherein the bit rate of the video data is reduced by reducing at least one of a frame size, a frame quality and a frame rate of the video data.

4. The method according to claim 1, wherein the digital A/V stream is compressed based on an MPEG standard.

5. The method according to claim 4, wherein the divided audio data is synchronized with the transcoded video data by matching Presentation Time Stamps (PTSs) of the audio and video data.

6. The method according to claim 5, wherein original PTSs of video data before the video data is transcoded are used for the transcoded video data.

7. The method according to claim 5, wherein new PTSs are used for the transcoded video data, and PTSs of the audio data are updated based on the new PTSs.

8. The method according to claim 7, wherein a start PTS value of the PTSs of the audio data is replaced with a start PTS value of the new PTSs of the transcoded video data, and the other PTS values of the PTSs of the audio data are updated based on the difference between the start PTS value of the new PTSs of the transcoded video data and the start PTS value of the PTSs of the audio data.

9. The method according to claim 7 or 8, wherein the transcoding and the synchronizing are performed on a section-by-section basis, each section having continuous PTS values.

10. The method according to claim 1, further comprising temporarily storing the divided audio data before synchronizing the divided audio data with the transcoded video data.

11. The method according to claim 10, wherein the size of a buffer for temporarily storing the audio data is determined based on both a time required to transcode the video data and a bit rate of the audio data.

12. The method according to claim 1, further comprising recording the packetized digital A/V stream in a recording medium.

13. The method according to claim 1, further comprising transmitting the packetized digital A/V stream.

14. The method according to claim 1, wherein the compressed digital A/V stream is received via a digital broadcast or input through a multimedia player.

15. An apparatus for transcoding a digital audio/video (A/V) stream, the apparatus comprising:
a demultiplexer for dividing a compressed digital A/V stream into audio and video data;
a buffer for temporarily storing the divided audio data;
a transcoder for transcoding the divided video data;
a synchronizer for synchronizing the divided audio data with the transcoded video data; and
a packetizer for packetizing the synchronized audio and video data into a digital A/V stream.

16. The apparatus according to claim 15, wherein the transcoding comprises reducing a bit rate of the video data, and the bit rate of the video data is reduced by reducing at least one of a frame size, a frame quality and a frame rate of the video data.

17. The apparatus according to claim 15, wherein original PTSs of the video data before the video data is transcoded are used for the transcoded video data to synchronize the divided audio data with the transcoded video data.

18. The apparatus according to claim 15, wherein new PTSs are used for the transcoded video data, and PTSs of the divided audio data are updated based on the new PTSs to synchronize the divided audio data with the transcoded video data, and wherein the transcoding and the synchronizing are performed on a section-by-section basis, each section having continuous PTS values.

19. The apparatus according to claim 18, wherein a start PTS value of the PTSs of the audio data is replaced with a start PTS value of the new PTSs of the transcoded video data, and the other PTS values of the PTSs of the audio data are updated based on the difference between the start PTS value of the new PTSs of the transcoded video data and the start PTS value of the PTSs of the audio data.

20. The apparatus according to claim 15, wherein the size of a buffer is determined based on both a time required to transcode the video data and a bit rate of the audio data.

21. The apparatus according to claim 15, further comprising:
a digital broadcast receiver for receiving the compressed digital A/V stream via a digital broadcast; and
a recorder for recording the packetized digital A/V stream in a recording medium.

22. The apparatus according to claim 15, further comprising a transmitter for transmitting the packetized digital A/V stream to a client computer through a communication network.
